(19) United States
(12) Patent Application Publication
(10) Pub. No.: US 2012/0171337 A1
(43) Pub. Date: Jul. 5, 2012

(54) Dough Portioner

(75) Inventors: Bruce V. Campbell, Richmond, VA (US); James M. Prill, Richmond, VA (US)

(73) Assignee: AMF Automation Technologies, LLC d/b/a AMF Bakery Systems, Richmond, VA (US)

(21) Appl. No.: 12/984,928

(22) Filed: Jan. 5, 2011

(51) Int. Cl. A21D 8/02; B67D 7/16

(52) U.S. Cl. 426/231; 222/71

(57) ABSTRACT

The dough portioner 10 includes a manifold 36 defining a chamber 38 for receiving bakers dough or other viscous flowable material from a feed pump 14. A plurality of delivery channels 44 in communication with said chamber pass the viscous material to a dough cutter 66. A meter wheel 52 is positioned between the manifold and the cutter for receiving a stream of the material from each of the delivery channels and discharging the streams of material independently of others of said meter wheels.

### FIELD OF THE INVENTION

This disclosure concerns a portioner for dividing a viscous mass of material, such as baker's dough, into separate streams of material and dividing each stream into pieces that may be baked into buns, loaves etc.

### BACKGROUND

In the commercial baking industry large masses of dough are prepared that must be divided into smaller pieces that are the proper size and shape to be baked or otherwise cooked in the form of buns, loaves etc., and packaged, sold and delivered to supermarkets and restaurants. The bakery industry has developed various equipment for preparing dough on a continuous processing line, from the dough mixer through pumps, developers, dividers, and rounder bars, to ovens and packaging. The end product must be consistent in content, size, shape and appearance for acceptance by the customer. It is desirable that all of the dough streams move at the same rate and same volume through the dough divider so that the dough pieces all come through the process in the same size and weight.

One of the difficult steps of dough processing as described above is the consistent dividing of the on-coming dough stream moving from the auger pump and through the dough divider. The dough divider divides the dough into separate parallel streams of dough and then cuts the streams of dough into pieces that are the correct size for forming the correct size product.

For example, in some dough processing systems the mass of dough is moved from an auger pump into a chamber of the dough divider. The chamber has internal partitions that separate the dough into several dough streams and the partitions are shaped to guide the oncoming dough toward delivery channels. As the dough streams move out of the delivery channels, cutter blades that move in unison across the outlet ends of the delivery channels cut or “divide” the dough streams into smaller pieces. The dough pieces fall from the divider to a surface conveyor where they move in parallel spaced relationship through subsequent processing steps. Dough stream cutters are described in U.S. Pat. Nos. 4,424,236, 4,948,611, 5,046,940, 5,270,070.

Some prior art dough dividers have a chamber that receives dough from an auger pump and a plurality of delivery channels are positioned in the chamber that deliver separate streams of the on-coming dough from the chamber to a cutter. Internal partitions are positioned in the chamber, and the internal partitions guide the dough toward the delivery channels. The positions of the internal partitions are adjustable to change the amount of dough flowing to each delivery channel. Examples of these type dividers are disclosed in U.S. Pat. Nos. 5,264,232, 5,350,290, 5,356,652, 6,303,168.

A problem with dough dividers that use the adjustable internal partitions to guide the dough to delivery channels is that the adjustment of one internal partition tends to change the rate of dough movement for not only the one channel but also for the adjacent channels, making it difficult to create the desired settings of the partitions.

Another prior art dough divider uses delivery channels that include a flexible segment or “diaphragm” that can be squeezed to constrict the flow of dough through each delivery channel. An example is disclosed in U.S. Pat. No. 4,948,611. However, it is difficult to adjust the flows through the several delivery channels to create equal flows through the delivery channels, and it is difficult to produce duplicate dough pieces if the up stream pressure of the auger varies.

Another dough divider uses duplicate positive displacement vane pumps that are connected to a common drive device for operating all of the vane pumps in unison to produce duplicate dough streams through the delivery channels. Examples are disclosed in U.S. Pat. Nos. 5,536,517, 5,688,540, and 5,906,297. But a problem with this type of dough divider is that it appears that there is no practical way to adjust the output rates of the pumps to compensate for different delivery rates of each vane pump.

It would be desirable to have a portioner for receiving dough or other viscous flowable material from a pump, and to accurately divide the material into a plurality of separate streams of the material in duplicate volumes, with a means for independently, expediently and reliably adjusting the flow of the material through the delivery channels while the material divider is in operation.

### SUMMARY OF THE DISCLOSURE

Briefly described, this disclosure concerns a divider apparatus for forming a flowable viscous material from a mass of the material into proportioned streams. It may include a manifold with an internal chamber with an entrance opening for receiving the viscous material through the entrance opening into said chamber, and a plurality of delivery channels in communication with the chamber for passing the viscous material through the delivery channels in separate streams out of the chamber. A meter wheel may be positioned at each delivery channel for receiving each stream of the material and discharging the streams of material, and a plurality of motors, each motor in driving relationship with one of the meter wheels for rotating the meter wheels independently of the others of the meter wheels.

The motors may be servo motors. The meter wheels may be positive displacement rotary vane meters. Or the meter wheels may be positive displacement paired rotary lobe meters. Or the meter wheels may be positive displacement paired engaged toothed sprocket meters.

Another form of the invention may be a manifold with a chamber with at least one entrance opening for receiving said material through said entrance opening into said chamber, and a plurality of delivery channels in communication with said chamber for passing the viscous material out of said chamber through the delivery channels in separate streams, and a meter wheel positioned at each of the delivery channel for receiving each stream of said material and discharging each stream of material, the meter wheels being rotatable about upwardly extending parallel axes.

A plurality of motors may be positioned below and in driving relationship with the meter wheels and configured for rotating its meter wheel independently of the others of said meter wheels.

The divider apparatus may include a pump for receiving the material from a supply of the material and for moving the material through the entrance opening into the manifold chamber. The pump may be an auger pump. A pressure gauge may be in communication with the manifold chamber for regulating the operation of the pump. A homing sensor may be provided for each meter wheel for determining the movement of each meter wheel and for adjusting the rate of rotation of the meter wheel in response to the detection by the homing sensor of the meter wheel. The homing sensors may be arranged to momentarily increase the rotation of the meter wheels in response to detecting the movement of a portion of the meter wheel. And some of said homing sensors may be configured to rotate some of the meter wheels out of phase with respect to others of the meter wheels.

The meter wheels and the servo motors may be independently mounted to the manifold with respect to others of the meter wheels and servo motors.

### BRIEF DESCRIPTION OF THE DRAWINGS

FIG. 1 is a side cross-sectional view of the dough portioner.

FIG. 2 is a plan view of the dough portioner of FIG. 1, taken along lines 2-2 of FIG. 1.

FIG. 3 is an enlarged view of the dough divider of FIG. 2.

FIG. 4 is an enlarged view of the dough divider of FIG. 1.

FIG. 5 is a perspective view of a positive displacement paired rotary lobe meter.

FIG. 6 is a perspective view of a positive displacement rotary vane meter.

FIG. 7 is a side view of a positive displacement eccentric rotary lobe meter.

FIG. 8 is an end view of the dough portioner.

### DETAILED DESCRIPTION

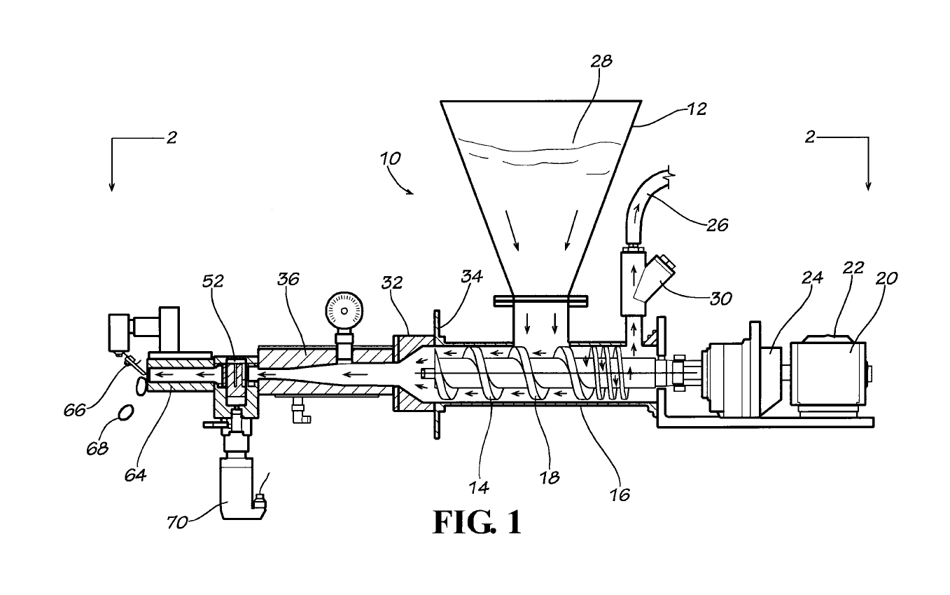

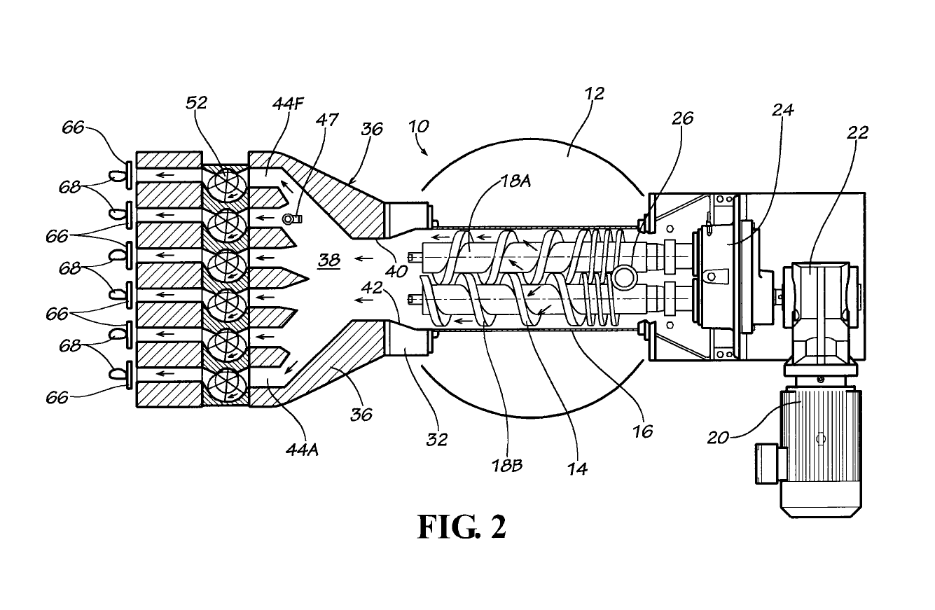

Referring now in more detail to the drawings in which like numerals indicate like parts throughout the several views, FIGS. 1 and 2 show dough portioner 10 that includes a dough hopper 12 mounted on a horizontal auger pump 14. Auger pump 14 includes a pump housing 16 that forms a tunnel in which an auger assembly 18 is positioned. As shown in FIG. 2, a pump such as a dual auger assembly may include a pair of spiral augers 18A and 18B that have overlapping spiral threads extending through the tunnel of the pump housing. Also, a single auger pump may be used or other pump concepts used, as may be desired.

As shown in FIG. 2, auger drive motor 20 is connected to gear reducer 22 and gear reducer is connected in turn to gear box 24. Gear box 24 is connected to the pair of augers 18A and 18B for rotating the augers.

As shown in FIGS. 1 and 2, air suction conduit 26 is connected to the auger pump housing 16 and is in communication with a conventional source of vacuum so as to continuously draw a vacuum in the pump housing 16. This tends to withdraw the air bubbles from the dough 28 that are present in the dough. Filter 30 is inserted in the air suction conduit 26.

At the other end of the auger pump, transition block 32 is mounted in alignment with the delivery end 34 of pump housing 16, and manifold 36 is releasably mounted to the transition block 32.

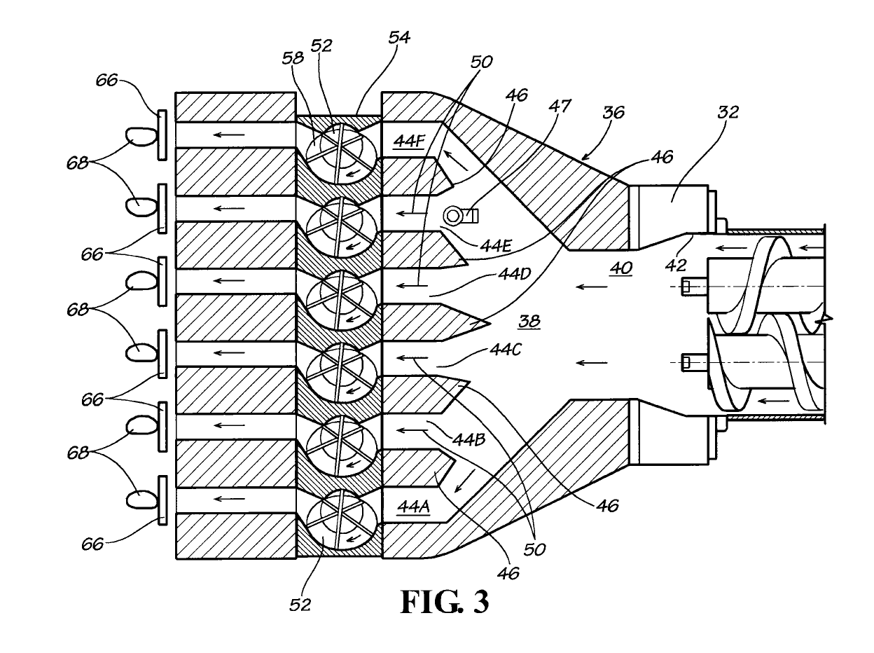

As best illustrated in FIG. 3, manifold 36 includes internal chamber 38 and defines an entrance opening 40 that is aligned with the transition block opening 42. A plurality of dough delivery channels 44A-44F are divided from one another by internal flow partitions 46. The internal flow partitions are shaped so as to direct the oncoming mass of dough toward the dough delivery channels 44A-44F. The pressure of the dough mass in the internal chamber 38 of the manifold 36 tends to spread the dough between the diverging inner walls 48 and 49 of the manifold internal chamber 38 so that each dough delivery channel 44A-44F becomes filled with dough.

The internal dough delivery channels 44 form the dough in a plurality of parallel streams of dough, as indicated by arrows 50.

As best shown in FIGS. 3 and 6, a plurality of meter wheels 52 are positioned in alignment with each parallel stream of dough 50 moving through each dough delivery channel 44A-44F. Each meter wheel 52 includes a positive displacement metering means, such as a position displacement vane meter wheel 52 that includes a rotor 55 with vane slots 54 extending outwardly from the axis of rotation. The sliding vanes 56 engage the inner circular surface 58 of the housing 60. The axes of rotation of the rotors 55 are parallel to one another and extend upwardly. The axes of rotation are offset from the central portion of the inner circular surface 58 so that the springs 62 (FIG. 6) positioned in the vane slots 54 push the sliding vanes 56 into engagement with the facing inner circular surface 58 of the meter housing 60. In this manner, the expanding chambers 63 on one side of the rotor 55 tend to induce the stream of dough 50 to move into the meter housing and the contracting chambers 65 on the other side of the rotor tend to expel the dough from the meter housing. This causes the dough streams to move through a discharge ports 65 of the discharge conduits 64 where the plurality of knives 66 driven by knife motor 67 move in unison in downward strokes to cut the leading ends of the dough stream 50 away from the oncoming dough streams and into smaller pieces 68.

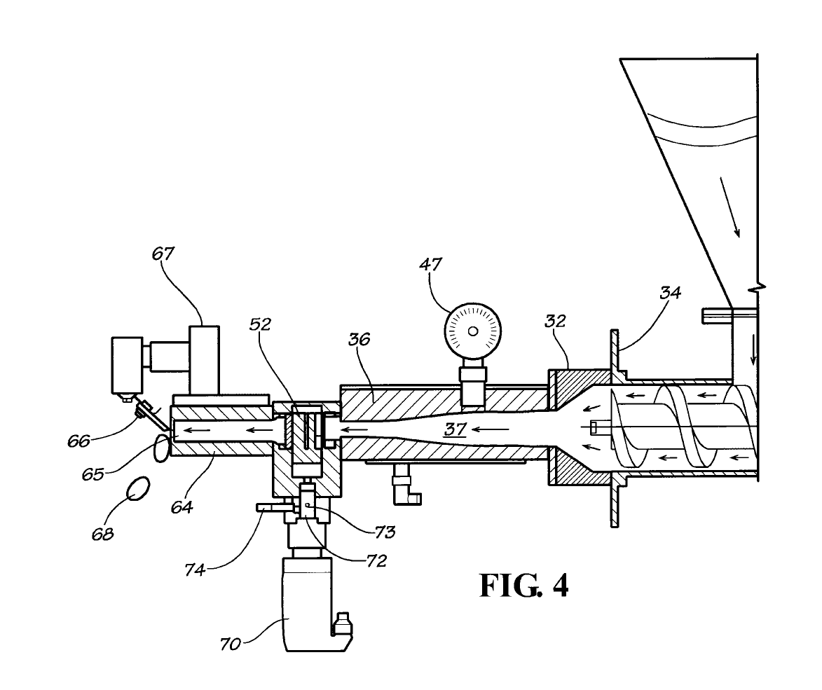

As best shown in FIG. 4, the meter wheels 52 are each connected to a servo motor 70. Each servo motor may be set to run at specific rpm so as to rotate its meter wheel 52 at the desired rpm. The speed of operation of the servo motors may be adjusted to adjust the volume of dough discharged from each meter wheel. This assures that an exact amount of dough will be moved by the meter wheels from the manifold 36 to the discharge conduit 64. The cutoff knives 66 move at a predetermined rate so as to cut off the end portions of the dough streams from the discharge ports 65.

As shown in FIG. 4, the servo motor 70 includes an axle 72 that extends from the motor to the meter wheels 52. The axle includes a mark 73 that rotates with the axle and a homing sensor 74 positioned in alignment with the mark and detects the passing of the mark on each rotation of the axle and therefore on each rotation of its meter wheel. Inasmuch as the movement of the sliding vanes passing the inlet and outlet of the meter wheel tend to form an instantaneous disruption of dough flow into and/or out of the meter wheel, the homing sensor 74 tends to instantaneously increase the rpm's of the meter wheel, thereby compensating for the slight reduction in dough flow through the meter wheel.

Each meter wheel 52 has its own servo motor 70. With this arrangement, if one of the meter wheels is not performing at the correct rpm's, an adjustment may be made to independently adjust the non-performing meter wheel, to increase or decrease the rate of flow of the dough through the meter wheel. For example, if one of the meter wheels has a slight imperfection in one of its vanes, or if the sizes or shapes of the meter wheel rotor 55 or any one of the sliding vanes 56 is not sized accurately, the servo motor has the potential of increasing and/or decreasing the rate of rotary movement of the meter wheel. This adjusts the volume of flow of the material through the meter wheel.

The servo motors 70 each are independently mounted in alignment with their respective delivery conduit so that each meter wheel may be removable and replaced independently of the other meter wheels. The axes of rotation of the meter wheels are parallel and extend upwardly. A servo motor 70 is mounted to each meter wheel at a position below each meter wheel and may be withdrawn downwardly (FIG. 1), away from its meter wheel, and replaced by a substitute servo motor, as might be necessary. Also, the meter wheels may be withdrawn upwardly between the manifold 36 and the discharge conduit 64, if necessary, without requiring disruption of the adjacent meter wheels

The servo motors operate independently of the other servo motors, so that each meter wheel is moved independently of the others. If it is desired to produce dough balls of different sizes during a single run of the dough portioner, one motor and its meter wheel may be operated at a faster rpm than another motor and its meter wheel.

The operation of one servo motor and its meter wheel may be terminated so as to terminate the flow of dough through the associated discharge conduit 64, while the other meter wheels continue to operate. This might be desirable in a situation where larger pieces of dough 60 emerging from the discharge conduit 64 may be produced, such as for hot dog buns.

Further, if one of the meter wheels 52 or servo motors 70 becomes inoperative, they may be expediently changed out with replacement meter wheels and/or servo motors, without having to remove others of the meter wheels or servo motors.

Further, the manifold 36 can be disconnected from the transition block 32 for expedient cleaning of the dough cutter.

Manifold pressure gauge 47 communicates with internal chamber 37 of manifold 36, and the pressure is used to control the rate of rotation of the augers 18A and 18B, thereby maintaining a relatively constant flow and pressure of the dough through the internal chamber 37 toward the meter wheels 52.

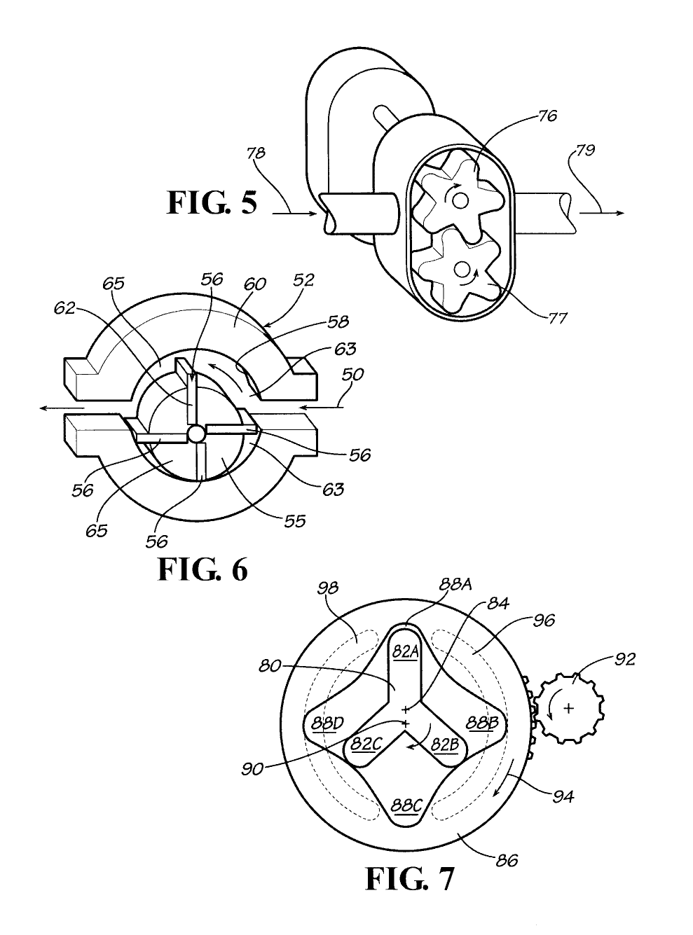

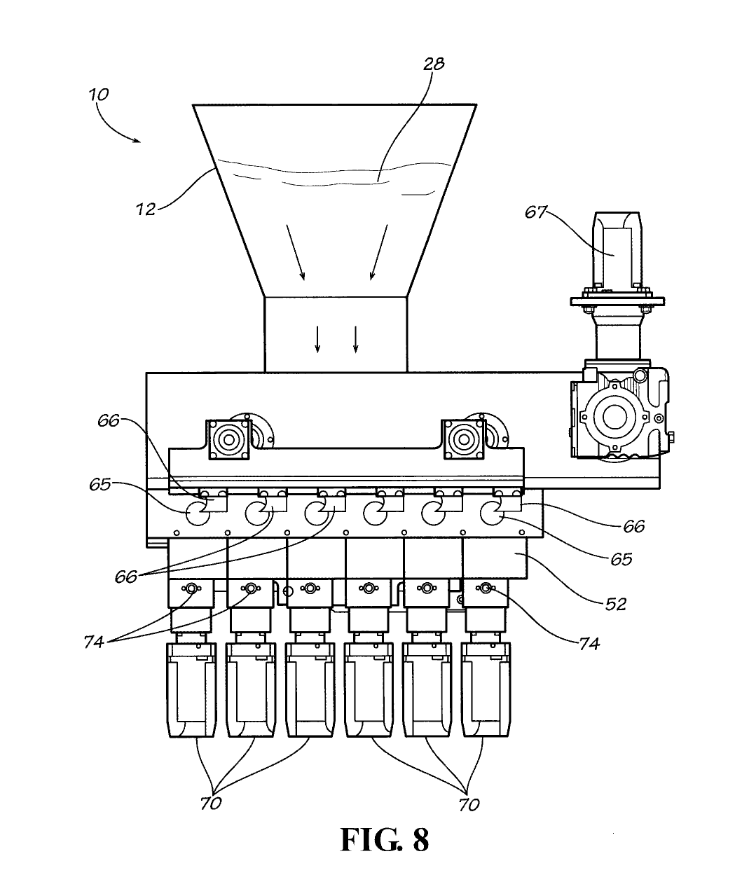

While the meter wheels are illustrated as sliding vane meter wheels, other types of meter wheels may be used. For example, FIGS. 5 and 7 illustrate meter wheels of different designs that may function in the desired manner for supplying dough from the manifold 36 to the dough delivery channels 44A-44F. FIG. 5 shows a pair of lobed rotors 76 and 77 which rotate in engagement with each other, and which may function to move viscous material as shown by arrows 78 and 79. The lobed rotor meter wheels are positive displacement so as to provide a desired volume of work product per unit of time.

FIG. 7 illustrates a meter wheel that is a positive displacement paired engagement sprocket meter wheel. The internal lobed rotor 80 has its lobes 82A, 82B, and 82C movable about an axis 84, while the external receiving ring 86 has a larger number of lobe recesses 88A-88D that rotate about an axis 90 that is offset from the axis 84. External drive sprocket 92 and its motor (not shown) rotate the external receiving ring 86 in the direction of arrow 94 and the engagement of the lobes 82A-82C with the lobe recesses 88A-88D results in the lobes 82A-82C displacing the dough through the entrance opening 96 in an end plate to the outlet opening 98 in the opposite end plate.

The meter wheels of FIGS. 5, 6 and 7 are considered to be positive displacement meter wheels for providing a continuous flow of dough, each at a predetermined volume of the dough, through the delivery channels of the manifold to the cutoff knives.

While this disclosure concerns apparatus and process for forming bakers' dough, it should be understood that other flowable material may be formed and metered by the disclosed apparatus and process.

Although preferred embodiments of the invention has been disclosed in detail herein, it will be obvious to those skilled in the art that variations and modifications of the disclosed embodiment can be made without departing from the spirit and scope of the invention as set forth in the following claims.

1. Apparatus for forming a viscous material from a mass of the material into proportioned streams, comprising:
a manifold including a chamber with an entrance opening for receiving said material through said entrance opening into said chamber,
a plurality of delivery channels in communication with said chamber for passing the viscous material out of said chamber through the delivery channels in separate streams,
a meter wheel positioned at each said delivery channel for receiving each stream of said material and discharging the streams of material, and
a plurality of motors, each said motor in driving relationship with one of said meter wheels for rotating said meter wheels independently of the others of said meter wheels.

2. The apparatus of claim 1, wherein said motors are servo motors.

3. The apparatus of claim 1, wherein said meter wheels are positive displacement rotary vane meters.

4. The apparatus of claim 1, wherein said meter wheels are positive displacement paired rotary lobe meters.

5. The apparatus of claim 1, wherein said meter wheels are positive displacement paired engaged toothed sprocket meters.

6. The apparatus of claim 1, and further including a pump for receiving the material from a supply of the material and for moving the material through the entrance opening into said manifold chamber.

7. The apparatus of claim 6, wherein said pump comprises an auger pump.

8. The apparatus of claim 6, and further including a pressure gauge in communication with said manifold chamber for regulating the operation of said pump.

9. The apparatus of claim 1, and further including a homing sensor for each meter wheel for determining the movement of each meter wheel and for adjusting the rate of rotation of the meter wheel in response to the detection by the homing sensor of the meter wheel.

10. The apparatus of claim 9, wherein said homing sensors are arranged to increase the rotation of said meter wheels in response to detecting the movement of a portion of the meter wheel.

11. The apparatus of claim 9, wherein some of said homing sensors are configured to rotate a meter wheel out of phase with respect to others of said meter wheels.

12. The apparatus of claim 1, wherein said meter wheels and said servo motors are independently mounted to said manifold with respect to others of said meter wheels and servo motors.

13. The apparatus of claim 1, and further including means for terminating the operation of some of said metering wheels while continuing the operation of others of said metering wheels.

14. The apparatus of claim 1, and further including a cut off knife positioned in alignment with each delivery channel for cutting the streams of material into pieces of the material.

15. The apparatus of claim 1, and further including means for operating some of the meter wheels at different rates to produce work products of different sizes.

16. A method of forming a viscous material from a mass of the material into proportioned streams, comprising:
moving the material into a chamber,
moving the material from the chamber into a plurality of delivery channels in communication with said chamber for passing the viscous material through the delivery channels in separate streams,
as the material moves through each delivery channel, passing the material through a meter wheel positioned at each delivery channel, and
turning the meter wheels each at its selected rate to deliver separate streams of the material at predetermined rates from each delivery channel.

17. The method of claim 16, and wherein the step of moving the material from the chamber comprises moving the material with an auger.

18. The method of claim 16, and wherein the step of passing the material through a meter wheel comprises rotating each meter wheel with a motor positioned at each meter wheel.

19. Apparatus for forming a viscous material from a mass of the material into streams of equal volume, comprising:
a manifold including a chamber for receiving said material,
a feed pump for moving the material into said chamber,
a plurality of delivery channels in communication with said chamber for passing the viscous material through the delivery channels in separate streams out of said chamber,
a meter wheel positioned at each said delivery channel, said meter wheels each configured for receiving a stream of said material from one of said delivery channels and discharging the streams of material, and
means for operating each of said meter wheels independently of others of said meter wheels.

20. The apparatus of claim 19, and wherein said meter wheels comprise positive displacement meter wheels,
a plurality of motors, each said motor in driving relationship with one of said meter wheels for driving said meter wheels independently of the others of said meter wheels, and control means for adjusting the volume of the material moved by each of said meter wheels.

21. The apparatus of claim 20, and further including means for terminating the operation of some of said meter wheels while continuing the operation of others of said metering wheels.

22. The apparatus of claim 20, and further including a cut off knife positioned in alignment with each delivery channel for cutting the streams of material into pieces of the material.

23. The apparatus of claim 20, and further including means for operating some of meter wheels at different rates to produce work products of different sizes.

24. A method of forming a viscous material from a mass of the material into proportioned streams, comprising:
moving the material into a chamber,
moving the material from the chamber into a plurality of delivery channels in communication with said chamber for passing the viscous material through the delivery channels in separate streams,
as the material moves through each delivery channel, passing the material through a meter wheel positioned at each delivery channel, and
turning the meter wheels independently of one another, each at its selected rate, to deliver separate streams of the material at predetermined rates from each delivery channel.

25. The method of claim 24, and wherein the step of moving the material from the chamber comprises moving the material with an auger.

26. The method of claim 24, and wherein the step of passing the material through a meter wheel comprises rotating each meter wheel with a motor positioned at each meter wheel.

27. Apparatus for forming a viscous material from a mass of the material into proportioned streams, comprising:
a manifold including a chamber with an entrance opening for receiving said material through said entrance opening into said chamber,
a plurality of delivery channels in communication with said chamber for passing the viscous material through the delivery channels in separate streams out of said chamber,
a meter wheel positioned at each said delivery channel, said meter wheels each configured for receiving a stream of said material and discharging the stream of material, and
a plurality of motors, each said motor in driving relationship with one of said meter wheels for driving said meter wheels independently of the others of said meter wheel.

28. Apparatus for forming a viscous material from a mass of the material into proportioned streams, comprising:
a manifold including a chamber with t least one entrance opening for receiving said material through said entrance opening into said chamber,
a plurality of delivery channels in communication with said chamber for passing the viscous material out of said chamber through the delivery channels in separate streams,
a meter wheel positioned at each said delivery channel for receiving each stream of said material and discharging each stream of material,
said meter wheels rotatable about upwardly extending parallel axes.

29. The apparatus of claim 28, and further including:
a plurality of motors, each said motor positioned below and in driving relationship with one of said meter wheels and configured for rotating its said meter wheel independently of the others of said meter wheels.

30. The apparatus of claim 29, wherein said motors are servo motors.

31. The apparatus of claim 28, wherein said meter wheels are positive displacement rotary vane meters.
